(19) United States
(12) Patent Application Publication
(10) Pub. No.: US 2023/0232785 A1
(43) Pub. Date: Jul. 27, 2023

(54) Animal Bodysuit

(71) Applicant: Linda Partipilo, Las Vegas, NV (US)

(72) Inventor: Linda Partipilo, Las Vegas, NV (US)

(21) Appl. No.: 17/946,229

(22) Filed: Sep. 16, 2022

Related U.S. Application Data
(60) Provisional application No. 63/302,166, filed on Jan. 24, 2022.

(51) Int. Cl. A01K 13/00; A01K 11/00

(52) U.S. Cl. CPC A01K 13/006; A01K 11/00

(57) ABSTRACT

The present invention relates generally to the field of animal garments. More specifically, the present invention relates to an animal bodysuit or garment having a central portion, leg and tail portions, hood and at least one boot. The bodysuit or covering is designed to be worn on the body of an animal to collect any hair or pet dander shed by the animal by covering the head, tail, and legs of the animal. The covering also has at least one boot that can be worn on the feet or paws of the animal. The bodysuit or covering has at least one pocket. In addition, the bodysuit, garment or covering may have a pocket or flap below the tail and on the underside of the bodysuit to allow the animal to defecate and/or urinate while wearing the bodysuit.

### CROSS-REFERENCE TO RELATED APPLICATION

The present application claims priority to, and the benefit of, U.S. Provisional Application No. 63/302,166, which was filed on Jan. 24, 2022, and is incorporated herein by reference in its entirety.

### FIELD OF THE INVENTION

The present invention relates generally to the field of accessories for pets and other animals. More specifically, the present invention relates to a bodysuit for a domesticated pet and is primarily comprised of a bodysuit and at least one, but preferably four, boots to cover each of the pet's paws. The bodysuit is designed to be worn over the body of an animal to keep the pet warm and to collect any hair shed by the animal by covering the head, tail, and legs of the animal. The device also includes at least one boot that can be worn on the paws of the animal. The boot further attaches to the leg of the bodysuit and can be removably secured to the suit. The bodysuit has at least one pocket. In addition, the bodysuit may have a pocket or flap below the tail and on the underside of the bodysuit to allow the animal to defecate and/or urinate while wearing the bodysuit. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

Many individuals own and enjoy having domesticated animals such as cats or dogs. However, most cats or dogs regularly shed their fur. As a result, furniture, surfaces, clothing, vehicle interiors, floors and other surfaces which the animal comes in contact with may become covered with the fur of the pet. This is undesirable, as the fur must be removed from furniture and other items. This is especially true if individuals within a home or guests are allergic to pet hair or pet dander. Cleaning pet hair can also be an incredibly time-consuming process that must be done multiple times a week. However, some individuals may not possess a sufficient amount of time to regularly clean furnishings and their home of pet hair.

Therefore, there exists a long-felt need in the art for a device that eliminates the need to clean pet hair off surfaces, objects, or items within a home and/or vehicle. There also exists a long-felt need in the art for an animal bodysuit device that can be worn by a pet, and the device collects any hair that is shed from the pet. Further, there exists a long-felt need in the art for an animal bodysuit device that allows a pet to remain comfortable when wearing the garment and moving about as is ordinary.

The subject matter disclosed and claimed herein, in one embodiment thereof, comprises an animal bodysuit device. The invention relates to an animal bodysuit having a central body portion, hood, leg and tail coverings and at least one, but preferably four, boots to cover the animal's paws. The bodysuit is designed to be worn on the body of an animal to collect any hair or pet dander shed by the animal. The bodysuit further covers the head, tail, and legs of the animal. In addition, the device has at least one boot that can be worn on the feet or paws of the animal. The boot further attaches to the leg of the bodysuit and can be removed to facilitate putting on the suit. The bodysuit includes at least one pocket. In addition, the bodysuit may have a pocket or flap below the tail and on the underside of the bodysuit to allow the animal to defecate and/or urinate while wearing the bodysuit.

In this manner, the animal bodysuit device of the present invention accomplishes all of the forgoing objectives and provides a garment that eliminates the need to clean pet hair and pet dander off surfaces, objects or items within a home and/or vehicle. To do so, the device is worn by a pet and collects any hair or pet dander that is shed from the pet. The device also allows a pet to remain comfortable when wearing the device.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises an animal bodysuit. The invention is a bodysuit having a central portion covering the torso of the animal, leg and tail coverings attached to the central portion, a hood for covering the head of the animal and at least one, but preferably four, boots to cover the paws. The bodysuit is designed to be worn on the body of an animal, and is used with domesticated animals such as a cat or dog. The bodysuit is preferably manufactured from a fabric material that may be hypo-allergenic and is preferably breathable. However, one embodiment of the bodysuit may feature an insulating fabric to keep the animal warm in colder climates. The bodysuit may also have at least one panel that allows the body suit to breathe and keeps the animal cool. The suit further includes a zipper or other fastener, such as hook and loop fasteners, buttons, snaps or combinations thereof to allow the suit to be put on and removed from the pet.

The bodysuit preferably covers (i.e., encloses) the head, torso, legs, and tail of an animal to collect any fur or pet dander shed by the animal. The hood of the bodysuit has at least one continuous opening that allows the face (i.e., eyes, nose, snout,) to protrude out from the hood. In one embodiment, there may also be openings for the ears of the animal on the hood. The hood has at least one internal elastic band which secures the hood around the animal using a compressive or elastic force. Similarly, at least one internal elastic band may further be found around the openings of the legs of the bodysuit to secure the bodysuit to the legs of the animal in the same manner. The bodysuit may further have at least one fastener that is preferably in the form of at least one zipper that runs along the top area of the bodysuit from the head to tail area of the animal that allows the bodysuit to be secured around the animal and removed from the animal.

Any portion of the bodysuit may further include at least one pocket that may have a flap that can be secured to the outer surface of the pocket via at least one fastener. The portion of the bodysuit located underneath the tail of the animal may also have a pocket that may hold animal waste bags to collect the feces of the animal. That area of the bodysuit may also have an opening to allow feces to exit the anus of the animal. In addition, an opening may be present on the underside of the bodysuit that allows the animal to urinate while keeping the bodysuit in position on the handle. Both openings may further feature a removable flap in lieu of a pocket, and the flap is removably secured to the opening via at least one fastener.

The invention may also have at least one boot that can be worn on the feet or paws of the animal. The boot has a rigid, rubber sole that provides protection and traction for the animal and has an elastic cuff that aids in securing the boot to the leg of the animal via providing a compressive or elastic force against the leg and paw. In addition, the cuff may have at least one fastener. The legs of the bodysuit may have the same fastener type such that the boot can be secured to the legs of the bodysuit.

Accordingly, the animal bodysuit of the present invention is particularly advantageous as it eliminates the need to clean pet hair and pet dander off surfaces, objects or items within a home and/or vehicle by collecting any hair or pet dander that is shed from the pet. The device also allows a pet to remain comfortable when wearing the garment. In this manner, the animal bodysuit overcomes the limitations of existing methods of preventing and cleaning shed animal hair and pet dander known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of an animal bodysuit of the present invention in accordance with the disclosed architecture;

FIG. 2 illustrates a perspective view of one potential embodiment of an animal bodysuit or protective garment of the present invention in accordance with the disclosed architecture; and

FIG. 3 illustrates a perspective view of one potential embodiment of an animal bodysuit of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that eliminates the need to clean pet hair and pet dander off surfaces, objects or items within a home and/or vehicle. There also exists a long-felt need in the art for an animal bodysuit or garment that can be worn by a pet. The invention collects any hair or pet dander that is shed from the pet. Further, there exists a long-felt need in the art for an animal bodysuit, garment or pet covering that allows a pet to remain comfortable when wearing the garment or covering.

The present invention, in one exemplary embodiment, is comprised of an animal bodysuit, garment or covering having a central portion covering the torso, a hood, leg and tail portions and at least one, but preferably four, boots for covering the paws of the animal. The bodysuit, cover or garment is designed to be worn on the body of an animal, and is sized to fit a domesticated animal such as a cat or dog. Further, the bodysuit, garment or covering is preferably manufactured from a fabric material that may be hypo-allergenic and is preferably breathable and may have one or more filter vents in order to allow additional air exchange with the animal but the filter blocking hair or pet dander from leaving the interior of the garment or covering. However, one embodiment of the bodysuit, garment or covering may feature an insulating fabric to keep the animal warm in colder climates and an air filter, such as a HEPA style filter to allow air to cool the animal. The bodysuit, covering or garment may also have at least one panel that allows the body suit to breathe and keep the animal cool.

The bodysuit, garment or covering preferably covers (i.e., encloses) the head, torso, legs and tail of an animal to collect any fur or pet dander shed by the animal. The hood of the bodysuit has at least one opening that allows the face (i.e., eyes, nose, snout) to protrude out from the hood. In one embodiment, there may also be openings for the ears of the animal on the hood. The openings have at least one an internal elastic band which secures the hood around the animal using a compressive or elastic force. Similarly, at least one internal elastic band may further be found around each of the openings of the legs of the bodysuit, garment or covering to secure the bodysuit, garment or covering to the legs of the animal. The bodysuit, garment or covering may further have at least one primary fastener that may be at least one zipper that runs along the top area of the bodysuit, covering or garment from the head to tail area of the animal. In this manner, the bodysuit, covering or garment can be secured around the animal.

Any portion of the bodysuit, covering or garment may further include at least one pocket that may have a flap that can be secured to the outer surface of the pocket via at least one fastener or other closure. The portion of the bodysuit, cover or garment located underneath the tail of the animal may also have a pocket that may hold an animal waste bag to collect the feces of the animal. The area of the bodysuit, covering or garment may also have a continuous opening to allow feces to exit the anus of the animal. In addition, an opening may be present on the underside of the bodysuit that allows the animal to urinate while keeping the bodysuit, covering or garment on. Further, both openings may feature a removable flap in lieu of a pocket, and the flap is removably secured to the opening via at least one fastener.

The invention may also have at least one boot that can be worn on the feet or paws of the animal, and the boot has a rigid, rubber sole that provides protection and traction to the animal and has an elastic cuff that aids in securing the boot to the leg of the animal via providing a compressive or elastic force against the leg. In addition, the cuff may have at least one fastener, and the legs of the bodysuit, covering or garment may have some fastener type such that the boot can be secured to the legs of the bodysuit, cover or garment.

Accordingly, the animal bodysuit, garment or covering of the present invention is particularly advantageous as it eliminates the need to clean pet hair and pet dander off surfaces, objects, or items within a home and/or vehicle by collecting any hair or pet dander that is shed from the pet. The garment, covering or suit also allows a pet to remain comfortable when wearing the invention. In this manner, the animal bodysuit, garment or covering overcomes the limitations of existing methods of preventing and cleaning shed animal hair and pet dander known in the art.

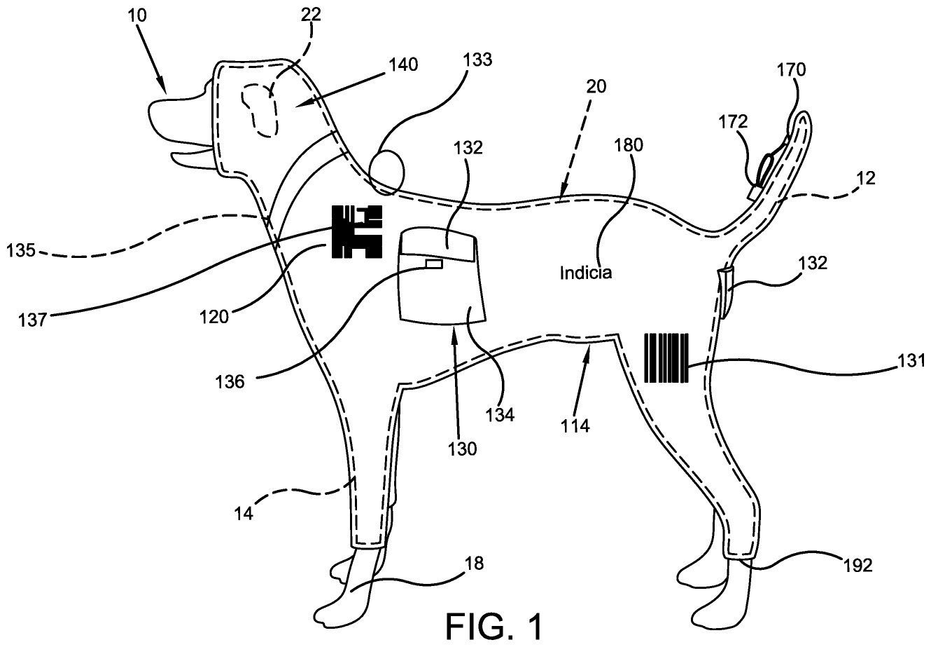

Referring initially to the drawings, FIG. 1 illustrates a side view of one potential embodiment of an animal bodysuit, garment or covering 100 of the present invention in accordance with the disclosed specification. The invention 100 has a bodysuit 110 with a central or torso covering, leg and tail, hood, and at least one, but preferably four, boots 200. The bodysuit, garment or covering 110 is designed to be worn on the body of an animal 10, such that the animal 10 is preferably a domesticated animal such as a cat or dog. However, differing embodiments of the invention 100 may be designed, sized and optimized for any type of animal. The bodysuit, covering or garment 110 is preferably manufactured from a fabric material such as, but not limited to: vinyl, canvas, cashmere, chenille, chiffon, cotton, damask, jersey, lace, linen, wool, modal, polyester, satin, silk, spandex, suede, tweed, twill, velvet, acrylic, modacrylic, nylon, polypropylene, polyurethane, polyvinyl chloride, polyethylene, vinylidene, benzoate, aramid, rayon, acetate, triacetate or any combination thereof. The fabric material may also be hypo-allergenic and is preferably breathable or has a filter port such as a HEPA filter 131. The filter 131 may be positioned at any part of the bodysuit, covering or garment. However, one embodiment of the bodysuit, covering or garment 110 may feature an insulating fabric to keep the animal 10 warm in colder climates in addition to the HEPA filter 131.

In order to ensure an animal 10 remains cool while wearing the bodysuit 110, the bodysuit, covering or garment 110 may have at least one panel 120, covering the torso of the animal that may be located on any portion of the bodysuit 110. The panel 120 is preferably manufactured from a breathable fabric material and/or a soft mesh material that allows the bodysuit, covering or garment 110 to breathe and keep the animal 10 cool while wearing the bodysuit 110. It should be noted that in an embodiment of the device 100 with a mesh panel 120, the spacing of the mesh panel 120 is such that the hair or pet dander of the animal 10 cannot escape the bodysuit, covering or garment 110 through the panel 120. In differing embodiments, the bodysuit, covering or garment 110 may be any color in the art and may comprise an indicia 180 such as, but not limited to, patterns, logos, emblems, images, symbols, designs, letters, numbers, words, characters, animals, advertisements, brands or combinations thereof.

The bodysuit, covering or garment 110 preferably covers (i.e., encloses) the head 16, torso 20, legs 14, and tail 12 of an animal 10. The hood 140 of the bodysuit 110, which covers the head 16 of the animal 10, has at least one opening 142. The opening 142 may allow the face (i.e., eyes, nose, snout) to protrude out from or be exposed under the hood 140. In one embodiment, there may also be openings 142 for the ears 22 of the animal 10 on the hood 140. The opening 142 has at least one internal elastic band 150 which secures the hood 140 around the head 16 of the animal 10 using a compressive or elastic force. At least one internal elastic band 150 may further be found around or within the openings 192 of the legs 190 of the bodysuit, covering or garment 110 to secure the bodysuit, covering or garment 110 to the legs 14 of the animal 10 in the same manner.

In order to further secure the bodysuit, covering or garment 110 around the animal 10, the bodysuit, covering or garment 110 has at least one primary fastener 170. In an exemplary embodiment, the fastener 170 is in the form of at least one zipper that runs along the top area 112 of the bodysuit, covering or garment 110 from the head 16 to tail 12 area of the animal 10. The zipper may have at least one pull tab 172 to aid in zipping the bodysuit 110 around the animal 10. However, the fastener 170 may be any other fastener type known in the art such as, but not limited to, magnets, snap-button, ties, adhesive, button and loop, hook and loop or combinations thereof. The covering or garment may include a loop 133 integrated with the covering 110 to allow for attachment of a leash or other restraint. The covering, garment or bodysuit 110 may also have a HEPA filter 131 to allow air exchange between the animal and the outside air without allowing release of the animal hair or pet dander. The covering 110 may also include retroreflective tape 135 which may be prismatic or a beaded film material to increase the visibility of the animal during low light situations. The covering 110 may also have a scannable device such as a QR Code or RFID tag 137 sewn in or printed on the tag of the covering or garment 110, so that in the event that the animal is lost, scanning the code or reading the tag will help locate the owner and bring pet and owner back together.

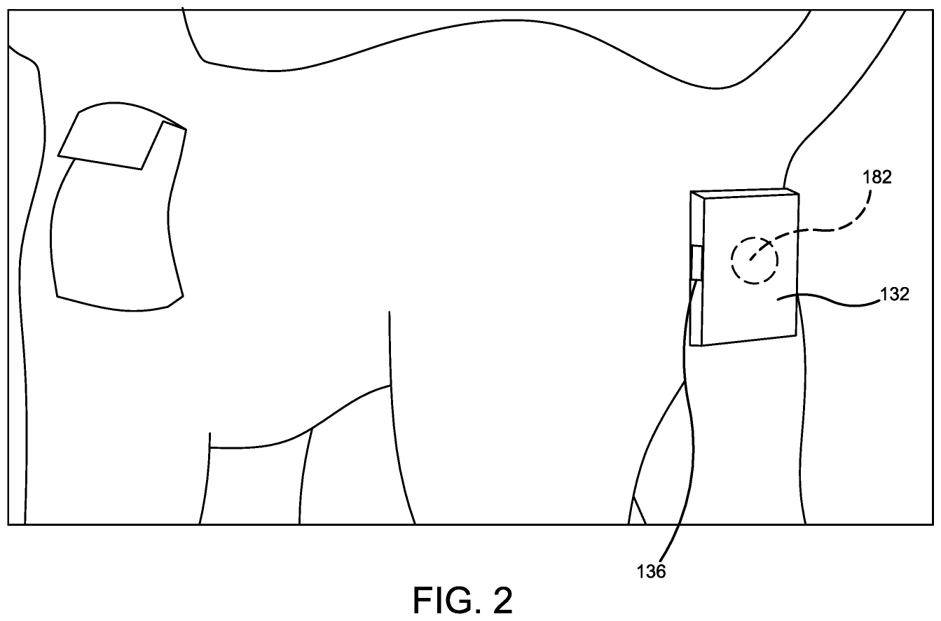

FIG. 2 illustrates a perspective view of one potential embodiment of an animal bodysuit, cover or garment 100 of the present invention in accordance with the disclosed specification. Any portion of the bodysuit, cover or garment 110 may further include at least one pocket 130 that can be used to store any item, toy, food product, medication or combinations thereof that relate to the animal 10 or belong to the owner or caretaker of the animal 10. The pocket 130 may have a flap 132 to secure the contents of the pocket 130 or may be an open-top pocket. The flap 132 may further be secured to the outer surface 134 of the pocket 130 via at least one fastener 136. The fastener 136 may be any fastener known in the art such as, but not limited to, magnets, snap-button, ties, adhesive, button and loop, hook and loop or combinations thereof. The portion of the bodysuit, cover or garment 110 located underneath the tail 12 of the animal 10 may have a pocket 130 that may hold an animal waste bag to collect the feces of the animal. The area of the bodysuit, cover or garment 110 may also include an opening 182 to allow feces to exit the anus of the animal 10. In addition, an opening 182 may be present on the underside 114 of the bodysuit, cover or garment 110 that allows the animal 10 to urinate while keeping the bodysuit 110 on. Both openings 182 may further feature a removable flap 132 in lieu of a pocket 130, such that the flap 132 is removably secured to the opening 182 via at least one fastener 136 that may be any fastener known in the art such as, but not limited to, magnets, snap-button, ties, adhesive, button and loop, hook and loop or combinations thereof

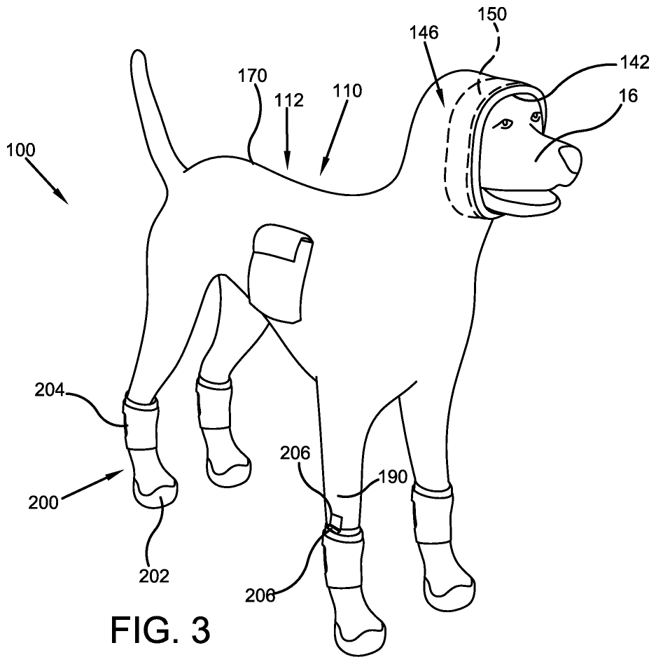

FIG. 3 illustrates a perspective view of one potential embodiment of an animal bodysuit, cover or garment device 100 of the present invention in accordance with the disclosed specification. The invention 100 may also have at least one boot 200 that can be worn on the foot or paw 18 of the animal 10. The boot 200 has a rigid, rubber sole 202 that provides protection and traction to the animal 10 when walking. The boot 200 further has an elastic cuff 204 that aids in securing the boot 200 to the leg 14 and paw of the animal 10 via providing a compressive or elastic force against the leg 14. In addition, the cuff 204 may have at least one fastener 206, and the legs 190 of the bodysuit, cover or garment 110 may have the same fastener 206 type. In differing embodiments, the fastener 206 may be any fastener known in the art such as, but not limited to: magnets, snap-button, ties, adhesive, button and loop, hook and loop, and combinations thereof. In this manner, the boot 200 can be secured to the legs 190 of the bodysuit 110.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “animal bodysuit device” and “device” are interchangeable and refer to the animal bodysuit device 100 of the present invention.

Notwithstanding the forgoing, the animal bodysuit device 100 of the present invention and its various components can be of any suitable size and configuration as is known in the art without affecting the overall concept of the invention, provided that they accomplish the above-stated objectives. One of ordinary skill in the art will appreciate that the size, configuration and material of the animal bodysuit device 100 as shown in the FIGS. are for illustrative purposes only, and that many other sizes and shapes of the animal bodysuit device 100 are well within the scope of the present disclosure. Although the dimensions of the animal bodysuit device 100 are important design parameters for user convenience, the animal bodysuit device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1 A covering for a domesticated animal, the covering comprising:
a central portion covering a torso of the domesticated animal;
a hood covering a head of the domesticated animal;
a set of leg portions covering a set of legs of the domesticated animal;
a tail portion; and
at least one flap connected to the central portion.

2. The covering as recited in claim 1, wherein the central portion is comprised of a pocket.

3. The covering as recited in claim 1 further comprising a filter element.

4. The covering as recited in claim 1, wherein the filter element is a HEPA filter element.

5. The covering as recited in claim 1 further comprising a retroreflective tape.

6. The covering as recited in claim 5, wherein the retroreflective tape is one of a prismatic tape or a beaded tape.

7. The covering as recited in claim 1 further comprising a QR Code or a RFID tag.

8. The covering as recited in claim 1 further comprising a boot connected to each of the set of leg portions.

9. The covering as recited in claim 1 further comprising an elastic band for securing each of the set of leg portions.

10. The covering as recited in claim 1 further comprising a fastener for securing the covering to the domesticated animal.

11. The covering as recited in claim 10, wherein the fastener is a select one of a zipper, a hook and loop fastener, a button, a snap or a combination thereof

12. The covering as recited in claim 1, wherein the hood comprises at least one opening.

13. The covering as recited in claim 12, wherein the at least one opening is for a nose, a mouth or an eye of the domesticated animal.

14. The covering as recited in claim 12 further comprising an additional opening for a pair of ears of the domesticated animal.

15. A garment for a domesticated animal, the garment comprising:
a central portion;
a hood;
a leg covering;
a tail covering;
at least one boot connected to the leg covering;
a filter embedded in the garment; and
a scannable device for providing information on the domesticated animal.

16. The garment as recited in claim 15, wherein the at least one boot is comprised of a rigid or a rubber sole.

17. The garment as recited in claim 15, wherein the central portion comprises an air filter.

18. The garment as recited in claim 15, wherein each of the hood and the leg covering comprise an elastic band for attaching the garment to the domesticated animal.

19. The garment as recited in claim 15, wherein the central portion comprises a pocket.

20. An animal bodysuit comprising:
a central portion;
a plurality of leg portions;
a tail portion;
a hood;
an elastic band positioned on each of the hood and the plurality of leg portions;
a boot connected to each of the plurality of leg portions;
a pocket connected to the central portion; and
a readable portion provided on the central portion, the readable portion being a select one of a QR code or a RFID tag.
